(19) United States
(12) Patent Application Publication
(10) Pub. No.: US 2026/0133219 A1
(43) Pub. Date: May 14, 2026

(54) METHOD OF CALIBRATING A PLURALITY OF METROLOGY DEVICES

(71) Applicant: ICSPI Corp., Waterloo (CA)

(72) Inventors: David MORRIS, Kitchener (CA); Zhenle CAO, Cambridge, MA (US); Dirk TJEPKEMA, Enschede (NL)

(21) Appl. No.: 19/389,512

(22) Filed: Nov. 14, 2025

Related U.S. Application Data
(60) Provisional application No. 63/720,528, filed on Nov. 14, 2024.

(51) Int. Cl. G01Q 40/00; G01Q 60/38; G01Q 70/06

(52) U.S. Cl. CPC G01Q 40/00; G01Q 60/38; G01Q 70/06

(57) ABSTRACT

In some embodiments of a method for calibrating metrology devices, an array of scanning probe microscopes (SPMs), such as AFMs, scan a plurality of targets on a wafer. Each SPM has a tip that moves vertically and also moves in at least one lateral direction. The AFM conducts a first scan at a wide FOV to locate the targets. For any misaligned AFMs, wherein the target is not within the zoom FOV of the AFM, the tip of such AFMs is actuated to move laterally to navigate to a respective target. Another scan is then performed at the zoom FOV to measure the targets. The array is then sequentially advanced, and the wide-and zoom-FOV scans are repeated, with navigation to correct misalignment as necessary, until all targets are scanned by all AFMs.

### FIELD OF THE INVENTION

The present invention relates to metrology.

### BACKGROUND

Metrology is the science of measurement, and is an extremely important consideration in most areas of science and engineering. Metrology involves the theoretical and practical aspects of obtaining accurate and consistent measurements.

Two important aspects of metrology are (1) accuracy-how close a measured value is to the “true” value, and (2) precision-the consistency of measurements under changed conditions.

Metrology finds significant application in semiconductor manufacturing, where it's applied during wafer preparation operations through to final inspection to ensure, among other goals, nanoscale precision in the manufactured devices. One type of semiconductor metrology is “dimensional metrology,” which measures critical dimensions, feature height, sidewall angle, and other aspects of surface structures. Common techniques for conducting dimensional metrology include CD-SEM, Scatterometry, Scanning Probe Microscopy (SPM), and interferometry and profilometry. These techniques are used to determine the aforementioned quantities as well as others, with a known accuracy, repeatability, and uncertainty.

Regardless of the technique used, a plurality of devices will typically be used to obtain measurements during semiconductor manufacturing. Consequently, there is a tool-to-tool matching issue. That is, each device being used must be calibrated with respect to all other devices, ensuring that they all provide the same measured value, to a defined accuracy, when measuring a particular feature at a particular location. Prior to calibration, variations in such a measurement will necessarily arise from a variety of factors known to those skilled in the art. And in the context of SPM, in which a sharp physical tip scans a surface, there is also a tip-to-tip matching issue, wherein there are likely to be differences from one tip to the next that must be addressed. Although tip-to-tip matching addresses physical probe-height differences, it also contributes to actual measurement-data match.

Consider that within the semiconductor metrology, the standard for matching is to measure more than 30 sites with each measurement device, obtaining more than 20 measurements with each such device. Landing multiple different probe tips, multiple times at a particular site is not trivial. And this matching routine must be accomplished quickly, since this procedure must be performed periodically, as well as any time a probe tip is replaced. The downtime represented by this operation can be significant, and should be minimized to the extent possible.

### SUMMARY

Among other capabilities, the invention provides a method to quickly and accurately calibrate a plurality of MEMS-based scanning probe microscopes (SPM), implementing both tool-to-tool matching (TTTM) and tip-to-tip matching. In the description that follows and the appended claims, an AFM (atomic force microscope) is referenced, which is one variety of SPM. Other types of SPM include scanning tunneling microscopy (STM), Magnetic Force Microscopy (MFM), Scanning Electrochemical Microscopy (SECM), and Scanning Kelvin Force Microscopy (SKFM). All disclosure herein pertaining to an AFM is equally applicable these other types of SPMs.

In accordance with the present teachings, and unlike the prior art, some calibration (and inspection) methods described herein utilize an array of MEMS-based AFM devices (hereinafter “AFM”), each of which is preferably actuatable in at least two dimensions, one vertical and (at least) one lateral. That is, each AFM in the array includes at least one MEMS-based Z-actuator (for actuation in the “Z” direction of up to about 100 microns), and (i) at least one MEMS-based X-actuator (for actuation in the “X” direction of up to about 80 microns), or (ii) at least one MEMS-based Y-actuator (for actuation in the “Y” direction of up to about 40 microns). The actuators move the cantilever/tip of each AFM. In some embodiments, each AFM in the array is actuatable in three dimensions.

Thus, although present in a 1D or 2D array, in preferred embodiments, each AFM has independent XZ, YZ, or XYZ control, by virtue of the various actuators. This facilitates unprecedented navigational control/error correction, and in conjunction with other aspects of the invention, ultimately improves measurement quality, measurement speed, and computational efficiency among any other benefits relative to the prior art.

The significance of this navigational control/error correction is illustrated in conjunction with FIG. 1, which depicts a key challenge for AFM tool-matching. In this figure, four conventional AFMs (not depicted) are scanning four regions of a wafer (not depicted). The “wide” field-of-view FOV_{W1}, FOV_{W2}, FOV_{W3}, and FOV_{W4} of each scan head is shown. In this example, the target—T₁, T₂, T₃, and T₄—being scanned in each region falls within the respective wide FOV of each scan head. But whereas target T₂ and T₃ fall within the zoom field-of-view FOV_{z2} and FOV_{z3} of the respective scan heads, targets T₁ and T₄ do not fall within the zoom field-of-view FOV_{z1} and FOV_{z4} of the other two scan heads. Since the four scan heads lack independent fine X, Y, or XY (hereinafter collectively “lateral”) control, there is no ability to alter the position of the two scan heads in question so that targets T₁ and T₄ fall within the zoom field-of-view FOV_{z1} and FOV_{z4} of those scan heads, as required to obtain a measurement. Consequently, no data can be obtained at those locations during that scanning pass.

In the aforementioned prior-art scenario, landing AFM probe(s) at an incorrect location requires disengaging the AFM probe(s) from the semiconductor wafer, and repositioning the scan heads via trial-and-error. This can result in substantial downtime, so the actual “up-time” for the AFMs (i.e., functioning to monitor semiconductor fabrication operations) is significantly reduced. Since semiconductor fabrication facilities seek to operate twenty-four hours per day, the downtime occasioned by having to re-position the AFMs is very costly.

This problem is addressed, in some embodiments, by the aforementioned array of MEMS AFMs in accordance with the present teachings, wherein the cantilever/tip of each AFM is independently movable in at least one lateral direction (in addition to moving vertically). Thus, if slightly misaligned but within the wide FOV of the AFM, the precise location of a target can be determined, and the AFM cantilever/tip actuated to move laterally to the precise location of the target.

It is notable that by virtue of its MEMS architecture, the AFMs can be fabricated as an array of AFMs (rather than individually), for example, in monolithic silicon. In some such embodiments, the array of AFMs is fabricated with a very precise (<1 micron), lithographically defined pitch. In some these embodiments, the AFMs will only include Z-direction actuation, but in some other these embodiments, both Z-direction and lateral direction actuation is included. Yet, even in the absence of lateral actuation, tool-to-tool matching is improved due to the precision of the pitch between the AFMs, which reduces the likelihood of misalignment. And in some embodiments, the pitch of the AFM array matches the pitch of targets/artifacts that are being scanned on a calibration wafer, which further reduces the likelihood of misalignment, and improves tool-to-tool matching.

Several specific examples of calibration/tool matching highlight some of the distinctions between embodiments of the invention and the prior art.

US2024/0295583 discloses a system in which four scan heads are finely positioned to regions of interest using a grid-plate system. The scan heads are then immobilized; the wafer itself moves to accomplish AFM scanning. If one of the scan heads lands in the wrong location, there is no way to correct such misalignment during the scan. Moreover, the various scan heads do not have the ability to perform a large field scan, and then zoom to the POV to a region of interest. This system is approximately 1000 to 10,000 times larger in volume the MEMS AFMs used in conjunction with the present methods. Such large volume makes matching more challenging because of a susceptibility to drift.

U.S. Pat. No. 10,712,364 discloses a metrology device including a first stage that incorporates a MEMS device having a probe, a second stage configured to hold a sample, and a kinematic coupler that constrains the first stage in six degrees of freedom and in a fixed position relative to the second stage. The probe of the MEMS device is supposedly precisely aligned with a feature of interest of the sample when the first stage is constrained in the fixed position relative to the second stage, and wherein the first stage is arranged on the second stage. The patent discloses using the kinematic coupler to land the MEMS devices onto the same sites repeatably across multiple wafers (with the same target coordinates for scan sites).

The device described in U.S. Pat. No. 10,712,364 does not allow for tool-to-tool or tip-to-tip matching, because the distances described therein are on the mm scale. To perform tool-to-tool matching, artifacts from across the entirety of the wafer must typically be scanned, and therefore all devices must be able to access all artifacts across the entire wafer. That device does not enable doing so.

In contrast, embodiments of the present method do not use a kinematic coupler. Rather, some embodiments of the invention describe a method where a plurality of AFMs scan multiple sites across a wafer, where the tip (probe) of each AFM lands on all of the sites, to perform matching.

In some methods in accordance with the present teachings:
An inspection step characterizes the cantilever/probe geometry of a plurality of MEMS-based AFMs (via imaging, scattering, or an electrical methodology);
Optional steps include:
   Storing the information obtained in the inspection step in memory of AFM and create a look-up table containing this information,
   A burn-in procedure is performed to improve tip matching,
   The probes and/or cantilevers are physically modified to improve tip matching,
   A hardware modification (e.g., tuning a variable resistor) is performed to improve matching;
The MEMS-based AFM devices are organized in an array (if they are not fabricated as such), optionally with a well-defined pitch between devices (although pitch need not be uniform due to the ability of each AFM device to navigate in the X, Y, or XY directions);
The array of AFMs is placed in a calibration system that includes a support for the array of AFMs, a sample and sample holder, and a stage for moving the sample in at least the Z direction;
After each AFM i in the array scans each site i, the array is then stepped by the pitch distance so that each device i scans site i+1. Navigational error correction is performed as necessary. This is continued for a desired number of sites for all AFMs i.
The difference in measured values for each device at each site is compared, such that both tool-to-tool matching and tip-to-tip matching is executed. This can be performed via procedures such as described in U.S. Pat. No. 8,467,993, incorporated by reference herein. It is notable that the manner in which the data is processed (i.e., statistical analysis) is not a focus of the present method, and is not discussed herein. There are a number of ways in which the data can be mathematical processed. Alternatively, as is the case for defect detection applications (known as “inspection” in the industry), the defect location(s) and number of defects can be compared, such that tool-to-tool matching and tip-to-tip matching is executed.

A key differentiator of some embodiments of the invention vis-à-vis the prior art is the manner of data acquisition, as facilitated by the lateral positioning capability of each individual AFM device in an array of such devices. This positioning capability enables each probe tip to independently land on the exact same target. Moreover, in some embodiments, individual AFM devices are fabricated in a monolithic silicon array with a well-defined and very precise pitch. This also facilitates matching, even in the absence of independent lateral positioning control.

Some embodiments of the invention provide a method that includes:
(a) positioning, at a first location, n, with respect to a first plurality of targets on a wafer, an array comprising a second plurality of MEMS-based atomic force microscopes (AFMs), each AFM having a tip that is actuatable to move in a vertical direction and at least one lateral direction, and wherein there are more targets in the first plurality than AFMs in the array;
(b) scanning, with each AFM, at a wide field-of-view (FOV), a number of targets equal to a number of AFMs in the array, wherein the scanning determines a location of respective ones of the targets by respective ones of the AFMs;
(c) for misaligned AFMs, wherein a respective target is not within a zoom FOV of said AFMs, navigating respective ones of tips thereof to respective determined locations of the respective targets by laterally actuating the tips of the respective misaligned AFMs;
(d) scanning the targets, with each AFM, at a zoom FOV, thereby obtaining a measurement of the respective ones of targets;
(e) advancing the array from location n to location n+1, and repeating (b) through (d); and
(f) repeating (b)-(e) until each AFM in the array has obtained the measurement of each target in the first plurality thereof,
   wherein, due to the tip of each AFM being actuatable in at least one lateral direction, each target will be within the zoom FOV of a respective AFM without having to laterally reposition an AFM.

Some other embodiments of the invention provide a method that includes:
(a) positioning, at a first location, n, with respect to a first plurality of targets on a wafer, an array comprising a second plurality of MEMS-based atomic force microscopes (AFMs), each AFM having a tip that is actuatable to move in a vertical direction, and wherein:
   (i) the targets have a first pitch, wherein the first pitch defines the separation between the targets,
   (ii) the array of AFMs are fabricated in monolithic silicon with a pitch that precisely matches the first pitch,
   (iii) there are more targets in the first plurality than AFMs in the array;
(b) scanning, with each AFM, at a wide field-of-view (FOV), a number of targets equal to a number of AFMs in the array, wherein the scanning determines a location of respective ones of the targets by respective ones of the AFMs;
(c) scanning, with each AFM, at a zoom FOV, thereby obtaining a measurement of the respective ones of targets;
(d) advancing the array from location n to location n+1, and repeating (b) and (c); and
(e) repeating (b)-(d) until each AFM in the array has obtained the measurement of each target in the first plurality thereof,
   wherein, since the pitch of the array precisely matches the pitch of the targets, each target will be within the zoom FOV of a respective AFM without having to laterally reposition the tip thereof, which, in the absence of an ability to laterally move the tip of each AFM, requires disengaging and then re-positioning the array of AFMs.

### BRIEF DESCRIPTION OF THE DRAWINGS

FIG. 1 depicts a prior-art tool-to-tool matching methodology.

FIG. 2A depicts an array of MEMS-based AFM, such as is usual in conjunction with embodiments of the invention.

FIG. 2B depicts an illustrative MEMS-based AFM, such as used in the array of FIG. 2A.

FIG. 3A depicts a method in accordance with the present teachings.

FIG. 3B depicts sub-operations of one of the operations of the method of FIG. 3A.

FIG. 4 depicts a system for characterizing cantilever and tip geometry.

FIG. 5 depicts, for several AFMs in an array, a variation in cantilever self-assembly angle.

FIG. 6 depicts a burn-in procedure to address a variation in cantilever/tip height, such as depicted in FIG. 5.

FIG. 7 depicts a physical modification procedure to improve tool-to-tool matching.

FIG. 8 depicts a metrology apparatus for calibrating an array of AFMs.

FIG. 9 depicts an array of AFMs scanning, in stepwise fashion, a plurality of targets on a wafer, in accordance with the present teachings.

FIG. 10A depicts an error in the position of an AFM during calibration.

FIG. 10B depicts navigational correction of the positional error shown in FIG. 10A, in accordance with an illustrative embodiment of the present invention.

FIG. 11 depicts multiple AFMs scanning a single target, in accordance with an illustrative embodiment of the present invention.

FIG. 12 depicts a methodology for improving data processing of information acquired by AFMs.

FIG. 13 depicts warpage of stitched AFM scans due to drift.

FIG. 14 depicts an arrangement for correcting for drift, in accordance with the present teachings.

### DETAILED DESCRIPTION

The following description illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended for pedagogical purposes to aid the reader in understanding the principles of the disclosure and the concepts contributed by the inventors to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The following terms are defined for use in this Specification, including the appended claims:
“About” and “substantially” mean +/−20% of a stated nominal size, quantity, etc.
“AFM” or “atomic force microscope” is one of variety of scanning probe microscopy techniques; reference to AFM herein is understood to apply more generally to scanning probe microscopes.
“Probe” or “probe tip” or “tip” are used interchangeably herein to reference the structure that interacts with the target to obtain measurements.
“Wide field-of-view” means a field of view (FOV) in the range of about 20 to about 100 microns.
“Zoom Field-of-view” means an FOV of about 5 microns or less.

For metrology applications, as opposed to inspection operations (such as to identify defects on a semiconductor chip), each MEMS-based AFM in an array thereof is, in preferred embodiments, independently movable in XZ, YZ, and XYZ directions. For navigational error correction, as described below in further detail, the ability to move in one or both lateral directions is important.

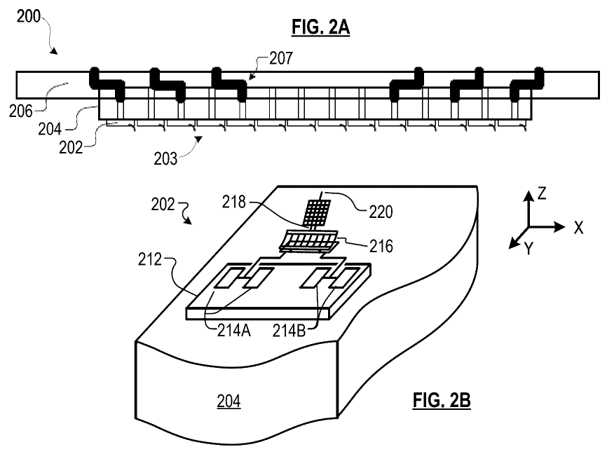

FIG. 2A depicts array 203 of MEMS-based AFMs 202 on a wafer 204, and FIG. 2B depicts detail of AFMs 202 in the array, as is suitable for use in conjunction with some embodiments of invention. See US2024/0361351, which is incorporated by reference herein. In the referenced publication, the AFMs are referred to as “SPMs” or “scanning probe microscope” devices.

In FIG. 2A, plural MEMS-based AFMs 202 are disposed on the front side of silicon wafer 204. Typically, wafer 204 is silicon, such as a 100 mm, 150 mm, 200 mm, or 300 mm silicon wafer. AFMs 202 are fabricated using, for example, a well-known CMOS-MEMS manufacturing process.

The back side of silicon wafer 204 is bonded to carrier substrate 206. Through-silicon vias (TSVs) 207 are used as interconnects to transfer power and data through carrier substrate 206, through silicon wafer 204, and to AFMs 202. The carrier substrate may be, for example, a printed circuit board (PCB) or other suitably stiff substrate having electrical interconnects. As discussed in US2024/0361351, AFMs 202 may be organized in any of a variety of ways, such as a monolithic array on silicon wafer, a plurality of relatively smaller arrays, each array on portion of a silicon wafer, or an array of “individual” AFMs (sans wafer), each mounted directly to a PCB substrate. In some embodiments, all probe tips are manufactured at the same time; in some other embodiments, they can be fabricated in separate processes.

FIG. 2B depicts one of AFMs 202, shown on a portion of wafer 204. AFM 202 includes electrically insulating (dielectric) and electrical routing layers 212, two paired x-y axes actuators 214A and 214B, z-axis actuator 216, piezoresistive sensor 218, and cantilever 220. In some embodiments, z-axis actuator 216 is an electrothermal bimorph actuator. By virtue of actuators 214A and 214B, and z-axis actuator 216, cantilever 220 is movable in the X, Y, and Z directions. At the end of cantilever 220 is a probe tip, which is too small to be depicted in this figure. The end of cantilever 220 has a width of approximately 6 microns, and the apex of the tip can be a small as about 2 nanometers (i.e., the tip can be greater than 1000 nanometers in length, and typically tapers from base to apex).

It will be appreciated by those skilled in the art that MEMS AFM device 202 is one of many implementations of a MEMS AFM, or more, generally, a SPM, useful for implementing the methods described herein. However, regardless of specific architecture, an AFM for use in conjunction with the methods is preferably actuatable in XZ, YZ, or XYZ directions when used for metrology applications. As previously mentioned, to the extent the array of AFMs is formed in monolithic silicon and has a lithographically defined pitch, even Z-only actuation will provide benefits for metrology applications. To maintain a focus on subject matter that is most germane to embodiments of the invention, the structure of the AFM will not be described in further detail.

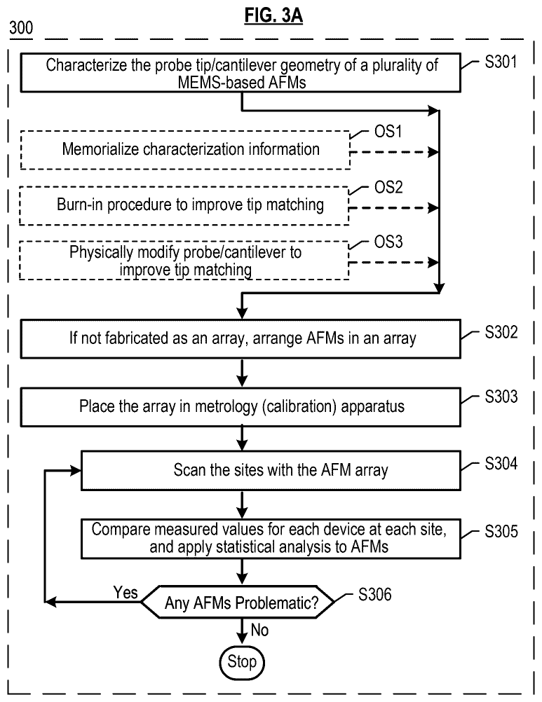

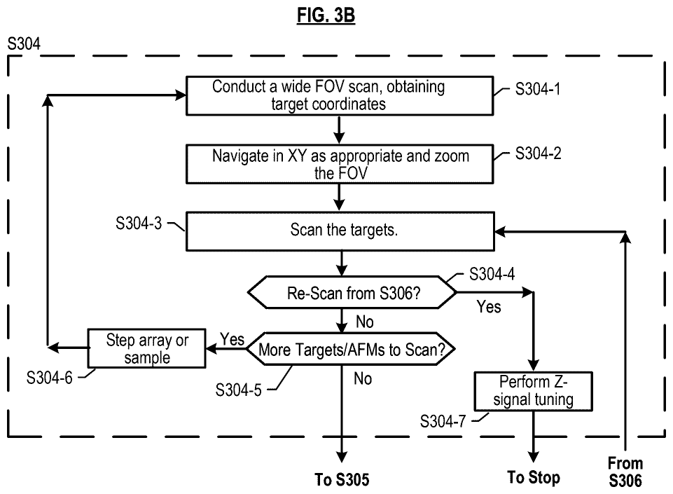

FIG. 3A depicts method 300 in accordance with the present teachings for calibrating an array of AFMs, such as array of AFMs 202 depicted in FIG. 2A.

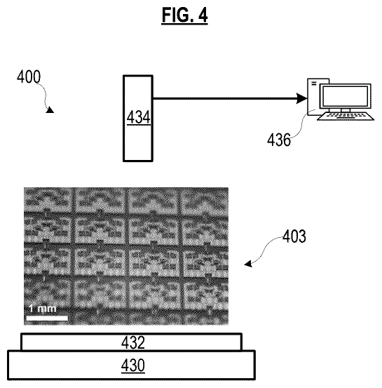

In operation S301 of method 300, the geometry of the cantilever and tip of plural AFMs are characterized. Operation S301 may be performed on an array of AFMs (if fabrication resulted in such an array), or, alternatively, may be performed on individual AFMs that are later arrayed. In either case, the probe tips/cantilevers are inspected to characterize their initial geometry. This is accomplished in known fashion, using a technique such as optical metrology, e-beam inspection, mechanical testing, or conductivity, among others. FIG. 4 depicts this characterization operation, performed on an 2D array of AFMs, as conducted by inspection system 400.

Inspection system 400 includes XYZ positioning stage 430, chuck 432 for securing sample, such a 2D array 403 of MEMS-based AFMs, inspection device 434 (e.g., e-beam, optical, etc.), and processor 436. Inspection device 434 obtains and transmits a signal representative of a map of array 403 to processor 436. Characterization information is obtained from the received signal using various data processing techniques, as is known in the art.

Additionally, the tip of each AFM may be inspected using an optical or electrical beam to obtain tip shape, wear characteristics and/or contamination. This inspection step may occur inside the inspection system itself. Optionally, the tip shape, wear characteristics, and contamination information may be collected by scanning the tips over a tip-wear structure, and/or using other signals, such as phase, multimode (higher frequency), force spectroscopy, etc., as is known in the art.

Furthermore, the geometry of the cantilever (which supports the tip), and actuators and/or flexures of each AFM is characterized. Each cantilever will have its own self-assembly angle. This angle results from the relief of residual stress when the cantilever is “released” (from the layer in which it was formed) during fabrication of the AFM. Differences in this angle between AFMs will result in a height mismatch of cantilevers and tips. And differences in the actuators and/or flexures may cause differences to mechanical motion during operation.

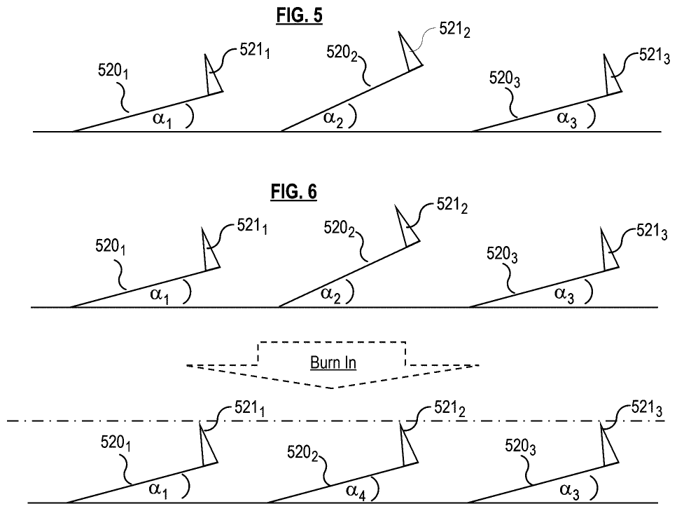

Mismatch of self-assembly angles is depicted in FIG. 5, where cantilever 520₁ of a first AFM has self-assembly angle α₁, cantilever 520₂ of a second AFM has self-assembly angle α₂, and cantilever 520₃ of a third AFM has self-assembly angle α₃. As shown in FIG. 5, assembly angles α₁ and α₃ are similar to one another, but dissimilar to assembly angle α₂. As a consequence of assembly angle α₂ being larger than assembly angles α₁ and α₃, both cantilever 520₂ and the associated tip 521₂ of the second AFM are “higher” than the cantilevers and tips of the first and third AFMs. Inspection of the cantilever/tip geometry can provide information that is used to “zero” all of the cantilevers.

In some alternative embodiments for use when the AFMs are arranged as an array as fabricated, the tips of the AFM in the array may be scanned using a reference array of probe tips. This approach obtains measurements in parallel wherein multiple probes in the reference array are scanning the plural probes in array being characterized. Such an approach is only possible due to the exacting positioning resolution facilitated by MEMS-based AFMs having XY navigational capability, as used herein.

In optional operation OS1, the characterization information obtained from inspection may be stored in memory associated with each AFM, either on-chip or off-chip, and/or encoded in a look-up table, such as is accessible to a processor associated with the metrology system. With regard to on-chip storage, in some embodiments, the AFMs used herein are fabricated in CMOS, unlike the prior art, in which fabrication is performed in “dumb” silicon. As such, in AFMs used herein, memory may be included in each AFM, or located elsewhere on the chip on which the AFMs are located.

Having characterized the AFMs, there are several optional operations that can be performed to improve tip-to-tip and tool-to-tool matching. These are depicted as optional operations OS2 and OS3 in method 300.

Referring now to FIG. 6, and as previously discussed in conjunction with FIG. 5, due to differences in cantilever self-assembly angle from AFM-to-AFM, the heights of the cantilever and tip are likely to vary between at least some of the AFMs of interest. In FIG. 6 for example, cantilever 520₂ and tip 521₂ of the second AFM are “higher” than the cantilevers and tips of the first and third AFMs. This height differential may be addressed, per operation OS2, via a “urn-in” procedure, wherein a stimulus (e.g., electrical signal, optical signal, heat, etc.) is applied to all or some of the AFMs.

In the example depicted in FIG. 6, a signal is applied to the second AFM (having cantilever 520₂ and tip 521₂). The signal may be, for example, an electrical biasing signal that is applied to the z-axis actuator of the second AFM for a period time, effecting a physical change. In this case, that physical change would be to drive the cantilever downward to match the heights of the cantilevers of the first and third AFMs, and permanently altering the quiescent-state (unactuated) height of the cantilever. Alternatively, cantilever 520₂ may be exposed to elevated temperature to anneal the cantilever, again permanently altering the quiescent-state height of the cantilever. A corrective signal to accomplish such a permanent height change may alternatively be applied during the calibration procedure (i.e., operation S303 of method 300).

In some other embodiments, rather than or in addition to changing the height of cantilever/tip, the response curve of the cantilever (e.g., force response, frequency response, etc.) is altered in known fashion. Thus, although the physical height of a cantilever might not change (or change sufficiently so that the height of all cantilevers/tips are equal), the effective zero of each AFM in the array is matched.

In addition to, or as an alternative to optional operation OS2, in optional operation OS3, the cantilever/tip of one or more AFMs is physically modified.

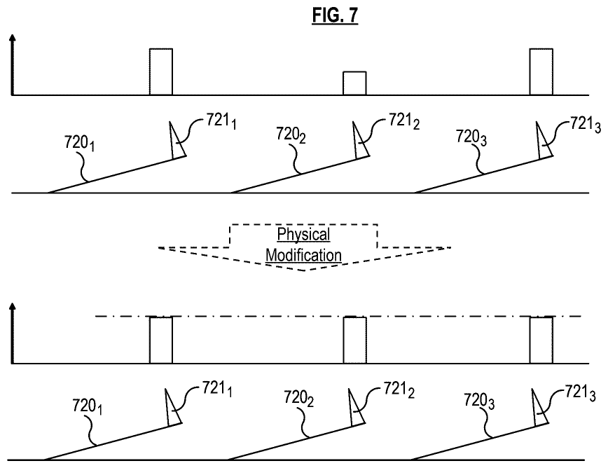

Physical modification of AFM structure can be effected by a process such as ion beam, laser, e-beam induced deposition, atomic layer deposition, atomic layer etching, among others. The intent of the modification can be to improve the tip-to-tip match of the individual AFMs of the array, or, alternatively, to improve the match of the data produced by the individual AFMs, such as depicted in FIG. 7. This figure depicts the cantilevers (cantilevers 720₁, 720₂, and 720₃) and tips (tips 721₁, 721₂, and 721₃) of three AFMs. The upper portion of the figure depicts the AFMs prior to physical modification. The associated plot shows that an arbitrary parameter (e.g., voltage, resistance, height, etc.) associated with each of the three AFMs. The plot associated with the untreated AFMs shows that the performance of the second AFM with respect to the parameter differs from that of the first and third AFM. After physical modification, the plot in the lower portion of the figure shows that the performance of all three AFMs with respect to the parameter is matched.

This optional operation may be performed during main fabrication, after inspection (S301), or as a repair step.

This operation can be performed on all AFMs in the array at the same time by using a traditionally parallel (blanket) technology, such as atomic layer deposition or chemical vapor deposition, with an electrical and/or thermal bias applied differently to each individual MEMS AFM. The electrical and/or thermal bias can also interact with the blanket etch/deposition technique differently, depending on the characteristics of the AFM tip. This enables higher productivity, relative to serial methods, by modifying all of the probes at the same time but by differing amounts to achieve matching. This also enables use of an often lower-cost tool. Alternatively, physical modification can be performed serially. Selectively modifying individual AFMs may be accomplished with a direct write technique, such as electron-beam induced deposition or focused-ion beam.

Techniques that may be used fall into three categories: (1) those that remove material, (2) those that add material, and (3) that modify material properties. Techniques that remove material include, without limitation, focused ion beam (FIB), laser ablation, selective etching (masked or unmasked) using gaseous, liquid or solid etchants. Techniques that add material include, without limitation, electron beam induced deposition (EBID), laser induced deposition, tip-based deposition, sputtering, thermal evaporation, and chemical vapor deposition. Techniques that modify material properties include, without limitation, thermal annealing, cryogenic treatment, and cold forming.

After characterization, and optional steps to improve tip matching, the plural AFMs are arranged in an array if not so fabricated, per operation S302. In embodiments in which the AFMs were formed as an array within silicon, the AFM device pitch (i.e., spacing between AFMs) may be selected to match the pitch of the regions of interest on the wafer being used for calibration. The pitch may be lithographically defined, among any other techniques.

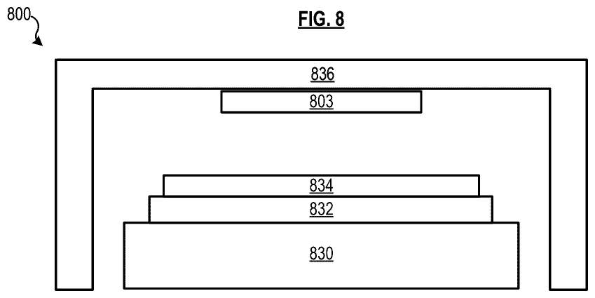

In accordance with operation S303, the array of AFMs is then placed in a metrology (calibration) apparatus. FIG. 8 depicts metrology apparatus 800 for use in calibrating the array of AFMs. Metrology apparatus 800 includes stage 830, chuck 832, calibration sample 834, AFM array 803, and frame 836.

Stage 830 is a positioning device, typically used to raise sample 834 into contact with AFM array 803. In some embodiments, stage 830 is a z-axis positioner. In some other embodiments, stage 830 may have positioning capability in any combination of Z, X, Y, theta, and tilt. Chuck 832, which is holder for sample 834, is disposed on stage 830. Sample 834 is a wafer, etc., having one or more very small features (“targets”) of known position and height, that are used to calibrate AFM array 803. Frame 836 supports AFM array 803 over sample 834.

After placing the AFM array in a metrology apparatus, the AFM array scans the targets at plural sites on a calibration sample, per operation S304. After each AFM in the array scans a target, the AFM array or calibration sample is stepped, and scanning of the targets continues. This process is repeated until all AFMs in the array scan the designated sites a requisite number of times. Typically, at least thirty targets are scanned, each AFM scanning each target at least twenty times. That amount of scanning collects enough data about the targets to compare the AFMs in a statistically significant manner. Operation S304 is described in further detail below in conjunction with FIGS. 3B, 9 and 10.

FIG. 3B depicts, via flow diagram, sub-operations of operation S304. Specifically, in accordance with sub-operation S304-1, a wide FOV scan is performed by each AFM in the array, by which the XY coordinates of the various targets are obtained. The wide FOV is typically in the range of about 20 microns to 100 microns. The resolution may be about 256×256 pixels to about 1024×1024 pixels; in the latter case, each pixel represents about 20 nanometers (nm) to about 300 nm.

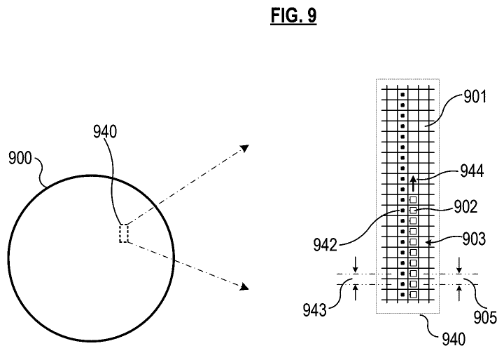

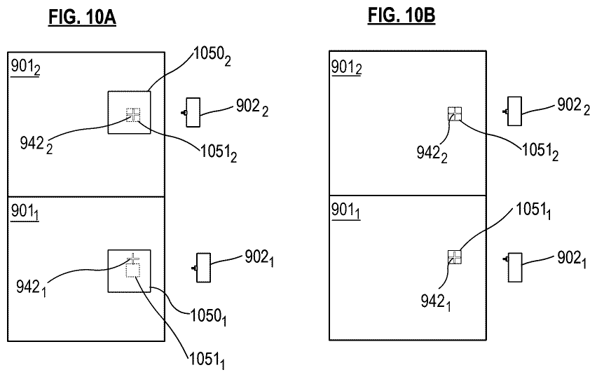

Per sub-operation S304-2, knowing the XY coordinates of each target, and to the extent there is navigational error for any of the AFMs, positional correction is effected via lateral-direction actuation of each misaligned AFM. After correction, each AFM will be able to land on the target and conduct a high-resolution scan of the target, per sub-operation S304-3. In some embodiments, the scanning is performed in an amplitude modulation mode, well known to those skilled in the art. The FOV of the zoom/high-resolution scan may be very detailed; from about 5 microns down to about 1 micron, with a resolution of about 512×512 pixels to about 2048×2048 pixels, each pixel representing from about 10 nm to as small as about 1 nm. Resolution can even be smaller than the probe tip, such as for oversampling, higher data quality, etc. Query in S304-5 whether additional scanning is required. If so, per sub-operation S304-6, the array or sample wafer is stepped, and sub-operations S304-1 through S304-3 are repeated. These sub-operations are further illustrated in FIGS. 9 and 10 below.

FIG. 9 depicts an array 903 of ten MEMS-based AFMs 902 aligned to scan the first ten of twenty targets 942 positioned on twenty sequential dies 901 of wafer 900. The targets being scanned are located in region 940 of wafer 900. For clarity of illustration, array 903 is a 1D array, and only twenty targets 942 and ten AFMs 902 are depicted. As previously noted, typically, the calibration procedure is performed on at least thirty targets with an array of least twenty AFMs.

In the illustrative embodiment, array 903 was fabricated with pitch 905 that matches the pitch 943 of targets 942 on wafer 900. This reduces XY offset of each AFM 902 relative to the target 942 it is scanning. Consequently, target 942 in each die 901 being scanned is expected to fall within the wide FOV of each AFM 902. This is illustrated in FIG. 10A, wherein in die 901₁, target 942₁ falls within the wide FOV 1050₁ of AFM 902₁, and in die 901₂, target 942₂ falls within the wide FOV 1050₂ of AFM 902₂.

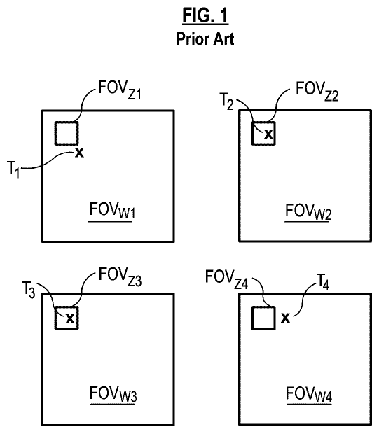

However, based on a slight positional error of AFM 902₁, target 942₁ will not be within zoom FOV 1051₁ of AFM 902₁. As previously noted (see description accompanying FIG. 1), were this the case in the prior art, it would not possible to obtain data at that location during that scanning pass. This is due to the lack of lateral navigational control of a prior-art misaligned scan head. Rather, the AFM would have to be disengaged from the semiconductor wafer, and repositioned via trial-and-error. In contrast, in embodiments of the invention, by virtue of independent lateral control of each AFM, the location of misaligned AFM may be corrected. This navigational error correction is depicted in FIG. 10B, wherein lateral-direction actuators are used to alter the location of the cantilever/tip of AFM 902₁ bringing zoom FOV 1051₁ into alignment with target 942₁. In this illustration, no such navigational correction is required to AFM 902₂ since, by virtue of its alignment, target 942₂ is within zoom FOV 1051₂.

Although AFM is primarily used as a Z-measurement technique, it's important in conjunction with embodiments of the invention that the XY axes are also calibrated and matched, since the AFMs used herein have the ability to move laterally. In this context, the targets can provide the relative positions of the AFMs. For example, in a situation in which the pitch of the AFM array is not well defined, the targets may be used to map out the location of the AFMs and understand the relative distances therebetween.

Additionally, thermal sensors integrated into the MEMS-based AFMs can be used for calibration, improving matching and improving defect location accuracy. More particularly, during a scan the temperature across the array might not be homogenous, so the performance of each of the MEMS in the array may differ as a consequence. Temperature affects almost all components of the MEMS, including the piezoresistors, actuators, and levers/flexures that constrain or amplify the motion of the actuators/sensors. As such, temperature will affect the scan results. Measuring the temperature and temperature-response curve will therefore facilitate matching the response and data collected by each of the MEMS AFMs in the array. In some embodiments, as an initial operation, the calibration wafer is scanned at different temperatures with the AFM array to obtain a temperature-response curve for the various components in each of the AFMs. In some embodiments, the temperature of the AFM array is also monitored during this operation.

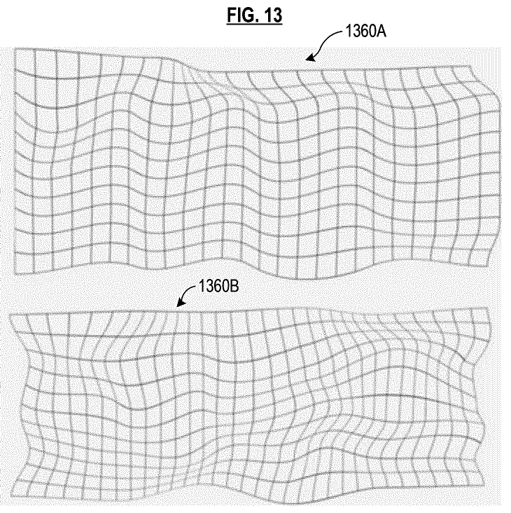

An important concept for navigational accuracy is “drift,” which is a gradual, systematic shift in the position of the AFM array relative to the target wafer, which causes errors in the output of the measurement tool (e.g., AFM, etc.) over time. And since scans may take many hours to complete, drift will be noticeable. Drift may be due to factors such as thermal expansion/contraction, aging components, environmental changes such as temperature or vibration, or wear and tear on the equipment. Drift is a non-random, systematic error that cannot be eliminated by taking multiple measurements and must be addressed through techniques like re-calibration or specific measurement strategies. At the size scale of relevance (i.e., a few nanometers), typical optical techniques cannot be used effectively. It is, in fact, very difficult to correct for this at the nanometer level. Due to drift, instead of obtaining a cartesian grid of stitched AFM scans, warpage occurs. As result, a grid of such stitched scans may appear like grips 1360A and 1360B depicted in FIG. 13.

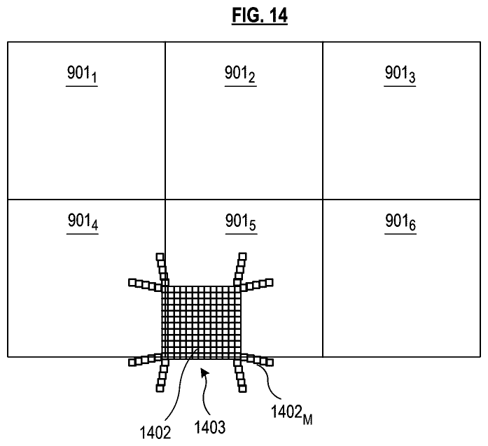

In accordance with the present teachings, to compensate for drift, additional AFMs are used as monitors, as depicted in FIG. 14. In this figure, several dies 901₁ through 901₆ are depicted. Array 1403 of AFMs 1402 is scanning targets in die 901₅. In the embodiment depicted in FIG. 14, array 1403 has a size of about 10 mm×10 mm. In addition to the 2D arrangement of AFMs 1402, array 1403 includes several “monitor” AFMs 1402_{M} (the figure depicts five staggered monitor AFMs 1402_{M} extending in the X and Y directions from each corner of the array 1403. These monitor AFMs 1402_{M} continuously monitor the edge(s) of the dies, typically scanning marks in the “scribe” lines that indicate the perimeters of the die. The monitor AFMs 1402_{M} thus provide die-level coordinates, which can be used to compensate for any drift. Thus, by knowing where the edges of the dies are, the position of each AFM is known, and can be matched, and defect location accuracy is also improved. In some other embodiments, monitor AFMs can be used in conjunction with a single AFM, again, to precisely determine its position.

After a requisite number of scans are completed, in operation S305, the various measured values for each device at each site are compared and statistical analysis is applied to the AFMs. Each AFM should measure the same value on a given target within a certain tolerance (as a function of the target size). For example, +/−0.1 nm may be a matching specification for the AFMs. In the case of defect detection (inspection), the number, type and location of the defects is compared instead of a certain tolerance. For example, one major defect and four minor defects within a certain area may be a matching specification.

If any of the AFMs are determined to be out-of-specification per the analysis of operation S305 (see query at S306) such AFMs may be re-scanned. In accordance with sub-operations S304-3, S304-4, and S-304-7, Z-signal tuning may be used to adjust the cantilever/tip height of any out-of-spec AFM so that it meets specification, such as the aforementioned +/−0.1 nm. This operation is commonly referred to as “turning knobs” in the industry. Sub-operation S304-7 is described in further detail below.

As previously noted, in the illustrative embodiment, AFMs are operated in amplitude modulation mode to perform the scanning operation. In this mode, the amplitude of oscillation of the AFM's cantilever is used as the feedback for the AFM. A change in sample topography causes the oscillation amplitude of the cantilever to change, due to intermolecular forces between the cantilever's tip and the sample. For example, an increase in topography means there is less room for the cantilever to oscillate, and the amplitude is reduced.

The oscillation amplitude is measured using a piezoresistive element. For example, when the oscillation amplitude decreases, the magnitude of the strain on the piezoresistive element decreases. The voltage applied to the Z-actuator will either be decreased or increased to move the cantilever/tip upwards or downwards such that the amplitude remains constant. The change in height of the cantilever/tip is used as the change in height on the sample (i.e., the actual measurement).

Since voltage is typically used as the sensor output, the data provides an empirical model that describes the relationship between voltage and the height measured by the sensor (i.e., the actual measurement collected by the AFM). That is, measured height on sample at a pixel is equal to a function of the voltage applied to Z actuator.

The “knob turning” is typically the modification of a signal applied to the Z actuator. In an illustrative embodiment, four signals sent to the Z actuator (i.e., Z-Fine, Z-Coarse, Z-drive, Z-level). One or more of these signals can be adjusted such that the scan heads have better matching. In some embodiments, there are more than one Z actuator on an AFM.

It is notable that the AFM tip itself will affect the aforementioned measurement, especially laterally. As previously described, the AFM tips in the array may be modified such that they physically match. This parallel tip matching procedure specifically for using the entire array as an imaging tool is unknown in the art. In other words, although the prior art has described procedures to make probe tips similar to each other at the same time (e.g., by ion milling, etc.), such tips are packaged separately and not used in an array. Moreover, in accordance with some embodiments, and unlike the prior art, modification is performed to the cantilever, sensor(s), flexures, as well, to provide matching of XYZ range and response.

It is notable that, in some embodiments, a test grating is scanned with the entire array, collecting topography data (tip shape), and then compensating in software using a tip deconvolution routine. Deconvolution is well-known in the industry.

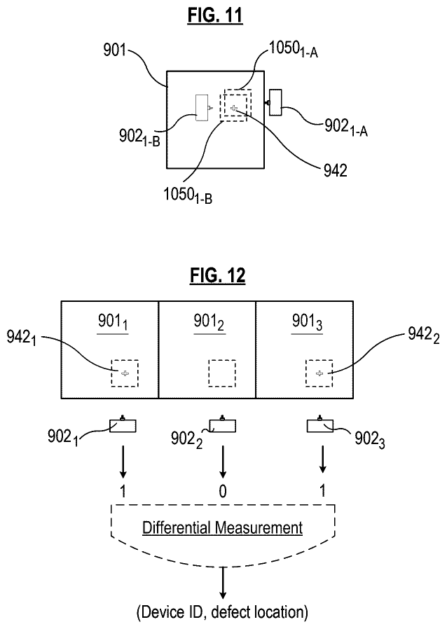

In some further embodiments, multiple AFMs can be positioned at the same target, as depicted in FIG. 11. In this figure, two AFMs 902_{1-A} and 902_{1-B} are positioned to scan target 942 in die 901 at the same time. Due to the lateral movement capabilities of the AFMs, slight deviations in their locations, as represented by the different wide FOVs 1050_{1-A} and 1050_{1-B}, present no impediment to such scanning. As previously noted, any misalignment is readily correctible. This enables replicates to be gathered in the same target area to improve matching. In yet additional embodiments, an individual AFM may include multiple cantilevers and multiple tips, which also facilitates gathering replicates.

FIG. 12 a methodology for reducing computational overhead. This figure depicts three die 901₁, 901₂, and 901₃, each being scanned by a respective AFM 902₁, 902₂, or 902₃. In this example, AFMs 902₁ and 902₃ measure the same value, a “1,” but device 902₂ measures a “0”. Rather than transmitting all of this data to a processor, and with little computational overhead, only the defect location and the identifier of the related AFM is transmitted.

It is notable that, in some embodiments, additional AFM devices are not used during scanning of product, but rather are only used for qualification and matching, especially to understand the wear characteristics between used and unused probes, to improve matching and data quality.

The AFM tips and devices themselves (actuators and/or flexures) will wear over time and affect the measurements. Tracking this wear digitally by collecting force and material-interaction data (e.g., multimode or phase data, as described previously), electrical resistance, optical properties, and the like, can improve the wear models and ultimately enable better matching, without necessarily performing a physical inspection. A digital version of the AFM tip (and device) can be constructed and modified with this wear data that is collected during manufacturing of the devices, inspection post-manufacturing or during operation.

What is claimed:

1. A method comprising:
(a) positioning, at a first location, n, with respect to a first plurality of targets on a wafer, an array comprising a second plurality of MEMS-based atomic force microscopes (AFMs), each AFM having a tip that is actuatable to move in a vertical direction and at least one lateral direction, and wherein there are more targets in the first plurality than AFMs in the array;
(b) scanning, with each AFM, at a wide field-of-view (FOV), a number of targets equal to a number of AFMs in the array, wherein the scanning determines a location of respective ones of the targets by respective ones of the AFMs;
(c) for misaligned AFMs, wherein a respective target is not within a zoom FOV of said AFMs, navigating respective ones of tips thereof to respective determined locations of the respective targets by laterally actuating the tips of the respective misaligned AFMs;
(d) scanning the targets, with each AFM, at a zoom FOV, thereby obtaining a measurement of the respective ones of targets;
(e) advancing the array from location n to location n+1, and repeating (b) through (d); and
(f) repeating (b)-(e) until each AFM in the array has obtained the measurement of each target in the first plurality thereof,
wherein, due to the tip of each AFM being actuatable in at least one lateral direction, each target will be within the zoom FOV of a respective AFM without having to laterally reposition an AFM.

2. The method of claim 1 comprising after all measurements are obtained, compare the measurements and apply a statistical analysis thereto.

3. The method of claim 1 wherein each AFM is actuatable in an X and a Y direction.

4. The method of claim 1 wherein the number of targets is at least 30 and the number of AFMs in the array is at least 20.

5. The method of claim 1 comprising inspecting the array to characterize, for each AFM in the array, a geometry of at least one structure selected from the group consisting of: a cantilever, the tip, an actuator, a flexure.

6. The method of claim 5 comprising memorializing the characterization information of each AFM in the array.

7. The method of claim 5 comprising storing the characterization information for respective ones of AFMs in respective ones of storage locations present in one of: each AFM, the array of AFMs, and a substrate containing the array of AFMs.

8. The method of claim 1 comprising inspecting a tip of each AFM in the array for wear characteristics and/or contamination.

9. The method of claim 5 comprising applying a stimulus to at least one AFM to adjust a height of a cantilever/tip thereof when the height differs from a desired height.

10. The method of claim 9 wherein the applied stimulus causes a permanent change in the height of the cantilever/tip.

11. The method of claim 5 comprising applying a stimulus to alter a response curve of the cantilever.

12. The method of claim 5 comprising physically modifying a cantilever/tip of respective ones of AFMs having a cantilever/tip that differs from a desired height.

13. The method of claim 5 comprising effecting a permanent height change to a cantilever/tip of an AFM by applying at least one of a corrective signal to the AFM or a physical change to a cantilever/tip, wherein the permanent height change may be performed during fabrication of the AFM, after the inspecting of the array, or as a repair step that occurs after all measurements are obtained, compared, and statistically analyzed.

14. The method of claim 1 comprising using a location of the targets to determine relative positions of the AFMs.

15. The method of claim 1 wherein the targets have a first pitch, which defines the separation therebetween, the method comprising fabricating the array to have a pitch equal to the first pitch.

16. The method of claim 1 wherein a thermal sensor is integrated into at least some of the AFMs in the array, the method further comprising measuring a temperature throughout the array of AFMs using the thermal sensor.

17. The method of claim 1 comprising correcting for drift in the relative positions of the array of AFMs and the wafer containing the targets by monitoring an edge of respective dies in which respective targets are located, wherein the monitoring is performed by monitor AFMs that are attached to the array, or an individual AFM.

18. The method of claim 1 comprising, after all measurements are obtained, identifying defects in one or more targets and a location of the defective targets.

19. A method comprising:
(a) positioning, at a first location, n, with respect to a first plurality of targets on a wafer, an array comprising a second plurality of MEMS-based atomic force microscopes (AFMs), each AFM having a cantilever/tip that is actuatable to move in a vertical direction, and wherein:
(i) the targets have a first pitch, wherein the first pitch defines the separation between the targets,
(ii) the array of AFMs are fabricated in monolithic silicon, the array having a pitch that is identical to the first pitch,
(iii) there are more targets in the first plurality than AFMs in the array;
(b) scanning, with each AFM, at a wide field-of-view (FOV), a number of targets equal to a number of AFMs in the array, wherein the scanning determines a location of respective ones of the targets by respective ones of the AFMs;
(c) scanning, with each AFM, at a zoom FOV, the first number of targets, thereby obtaining a measurement of the targets;
(d) advancing the array from location n to location n+1, and repeating (b) and (c); and
(e) repeating (b)-(d) until each AFM in the array has obtained the measurement of each target in the first plurality thereof,
wherein, since the pitch of the array precisely matches the pitch of the targets, each target will be within the zoom FOV of a respective AFM without having to laterally reposition the tip thereof, which, in the absence of an ability to laterally move the tip of each AFM, otherwise requires disengaging and re-positioning the array of AFMs.
